(19) United States
(12) Patent Application Publication
(10) Pub. No.: US 2026/0175976 A1
(43) Pub. Date: Jun. 25, 2026

(54) Hovering Laser Swarm Illuminating And Neutralizing Moving Targets

(71) Applicant: Oren Aharon, Haifa (IL)

(72) Inventor: Oren Aharon, Haifa (IL)

(21) Appl. No.: 18/991,576

(22) Filed: Dec. 22, 2024

(51) Int. Cl. B64C 39/02; B64U 20/96; B64U 101/18; B64U 101/31; F41H 13/00

(52) U.S. Cl. CPC B64C 39/024; B64U 20/96; F41H 13/0056; F41H 13/0062; B64U 2101/18; B64U 2101/31; B64U 2201/102

(57) ABSTRACT

High-power lasers generate substantial heat, often exceeding 50% of their total input power. This can degrade performance or cause catastrophic failures due to excessive temperatures. Special-purpose cooling units are available to manage this heat but are typically heavy and often rely on liquid cooling, making them unsuitable for use in flying drones. To address this challenge, the proposed concept utilizes a swarm of drones, each equipped with a relatively low-power laser. Each drone's laser is cooled by the air convection generated by its own propellers, eliminating the need for heavy cooling systems. The airflow is sufficient to maintain optimal laser operation. When higher power is required, such as for dazzling or damaging a target, the swarm collectively focuses all their lasers on the same target, combining their energy to achieve high-power levels effectively and efficiently while maintaining manageable thermal loads on individual drones.

### BACKGROUND OF THE INVENTION

### 1. Field of the Invention

The present invention relates to the integration of laser systems and drone technologies, specifically to the design and operation of drone swarms equipped with low-power lasers. The invention focuses on addressing challenges associated with thermal management and energy efficiency in aerial laser systems by utilizing distributed cooling mechanisms and cooperative targeting strategies. It is applicable to various fields, including defense, surveillance, aerospace, and precision targeting, where lightweight and efficient laser systems are required for reliable operation. The invention relates with drones equipped with lasers and cameras for discerning moving targets by laser illumination and image processing of camera output. Since this is achieved in a cooperative swarm type information from two or more drones could be also used to calculate the distance between the drones and the target by using the triangulation principle.

### 2. Description of the Related Art

High-power laser systems are commonly used in applications requiring precision and significant energy output, such as military targeting, industrial cutting, and scientific research. However, these systems generate excessive heat, often requiring specialized cooling units, which are typically heavy and rely on liquid cooling. This limits their integration into flying drones due to weight and space constraints.

Attempts to adapt laser systems for aerial platforms have largely focused on developing compact, high-power lasers or advanced cooling solutions. Single-drone platforms with high-power lasers face challenges in achieving adequate cooling using onboard systems, particularly when relying solely on airflow generated by propellers. These limitations make it impractical to use such systems in extended or high-energy operations.

The concept of swarm-based drones has been explored for applications like distributed sensing and coordinated attacks. However, the use of swarms to collectively direct laser energy at a target, leveraging multiple low-power lasers with distributed cooling, remains underdeveloped. Existing technologies do not address the combined benefits of decentralized cooling and energy aggregation from multiple drones, which the present invention seeks to achieve.

### SUMMARY

The present invention introduces a novel approach to deploying a swarm of drones, each equipped with a relatively low-power laser and a camera. The swarm operates cooperatively, with each drone contributing to a collective effort to illuminate and neutralize moving targets. By focusing all lasers on a single target, the swarm achieves a combined high-energy effect, capable of dazzling or damaging the target while overcoming the limitations of individual drones equipped with high-powered lasers.

A key feature of this invention is its innovative cooling mechanism. Unlike traditional high-power laser systems, which require heavy and complex cooling solutions, each drone in the swarm utilizes the airflow generated by its propellers for thermal management. This decentralized cooling approach ensures optimal laser performance without the need for liquid cooling or additional weight, making it highly suitable for aerial platforms.

The drones' cameras work in coordination to identify and track moving targets through laser illumination and image processing. Additionally, data from multiple drones in the swarm can be used to calculate the distance to the target using the triangulation principle, further enhancing precision and operational efficiency.

The proposed invention builds upon existing technologies but offers a unique implementation of cooperative swarms for laser energy aggregation and cooling. Related patents, such as KR102572422B1 which focuses on drone systems, does not implement laser and does not feature the innovative cooling for small laser, and ES2927298T3 which details coordinate robotic cooperative system does not overcome the cooling challenge of lasers, especially when mounted on a drone with limitation of weight and energy. However, they do not disclose or suggest the combined use of distributed low-power lasers and decentralized cooling mechanisms as described in this invention.

By addressing the limitations of high-power lasers in drones and introducing a scalable, lightweight, and effective system, this invention establishes a new paradigm in the field of laser-equipped aerial platforms, with potential applications in defense, surveillance, and other industries.

The invention relates to a drone-based laser system comprising a swarm of drones, each equipped with a low-power laser, a propeller-driven cooling mechanism utilizing airflow for heat dissipation, and rechargeable batteries for long-duration operation. The drones collectively focus their lasers on a common target, dynamically adjusting the intensity and focus of the combined output based on target distance and material properties to achieve high-energy effects capable of dazzling optical sensors or damaging physical components. Each drone features an onboard control system for autonomous operation, cameras for target detection, identification, and tracking, and wireless communication modules to ensure real-time data exchange and synchronization. The drones share positional data, perform triangulation for distance calculations, and coordinate laser alignment while dynamically repositioning within the swarm to optimize cooling and focus efficiency. The cameras further differentiate between multiple targets, assign priority levels, and integrate modular designs for scalability and maintenance. A central control unit monitors drone status and provides command instructions, enabling operation in various environmental conditions, including high altitudes and extreme temperatures. Additionally, the system can adjust laser output for non-lethal applications such as signaling or marking targets.

To summarize, the present invention provides a drone-based laser system in which a plurality of drones cooperatively detect, locate, and engage moving or stationary targets using coordinated laser emission and real-time data exchange.

Each drone carries a low-power laser emitter and a propeller arrangement that simultaneously provides flight propulsion and airflow-based cooling of the laser without auxiliary fans or liquid systems.

A control system governs operation in two modes:
a detection mode, during which each laser emits low-average-power, high-peak-power pulses to illuminate and scan a wide field of view; and a cooperative engagement mode, triggered upon target detection, in which the drones autonomously align and focus their laser beams on the identified target while increasing the average emitted power so that the combined energy is sufficient to dazzle optical sensors or damage physical components of the target.

Because the system operates predominantly in the low-power detection mode, the convective airflow generated by the propellers provides adequate cooling for continuous operation.

Each drone is equipped with an imaging sensor—preferably fitted with a band-pass filter passing primarily the laser wavelength—that receives back-reflected laser radiation from the target.

From the captured image frames, the onboard control system or central processor extracts motion vectors, computes reflectivity contrasts, and determines the angular direction of the detected target relative to the optical axis of each laser.

By triangulating the angular data from multiple drones, the control system precisely determines the three-dimensional spatial position of the target and commands coordinated laser focusing and swarm formation.

The imaging algorithms classify and prioritize detected objects according to motion, approach direction, or reflectivity, enabling optimized cooperative targeting of multiple threats.

The drones are interconnected through wireless communication modules that exchange positional, imaging, and thermal data in real time to ensure synchronized laser emission and stable beam convergence.

A central or distributed control unit monitors the operational status of each drone, manages flight geometry, and issues engagement commands.

The drones can dynamically reposition within the swarm to optimize both beam convergence and cooling efficiency, maintaining stable performance even under environmental variations.

Each drone may incorporate a temperature sensor that regulates or interrupts laser power when internal heating exceeds safe limits.

The laser-camera assembly of each drone is designed as a removable modular payload unit with standardized mechanical and electrical interfaces, simplifying maintenance, upgrades, and scalability of the swarm.

Power is supplied by rechargeable high-energy-density batteries that support long-duration flight in the detection mode and short high-power bursts in the engagement mode while sustaining propulsion and cooling functions.

The propeller-induced cooling mechanism is engineered for reliable operation at altitudes up to approximately 3 000 m and in ambient temperatures ranging from −20° C. to +50° C.

The system further allows selective adjustment of total laser output between a high-energy mode for target neutralization and a low-energy mode for non-lethal applications such as signaling, marking, or optical alignment calibration.

Through this configuration, the invention achieves a lightweight, air-cooled, and cooperative laser-engagement platform capable of precise target localization, adaptive power management, and scalable swarm operation-features not available in prior single-drone or continuously cooled laser systems.

### BRIEF DESCRIPTION OF THE DRAWINGS

FIG. 1 is a schematic diagram depicting the optical system of an autocollimator instrument.

FIG. 2 shows the projected reference cross, generated by three illumination sources, each illuminating the built-in cross of the autocollimator.

FIG. 3 describes a zooming autocollimator at a wide field of view position FIG. 4 describes same autocollimator in a narrow field position.

### DETAILED DESCRIPTION OF THE DRAWINGS

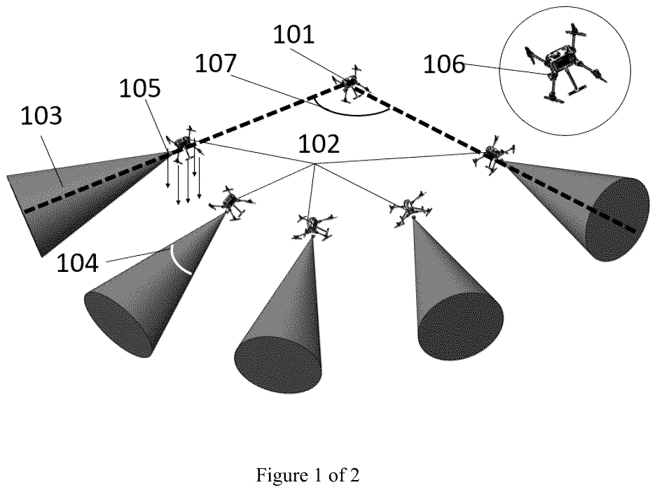

FIG. 1 illustrates a proposed swarm system in which a central drone, labeled as 101, performs a controlling function. This drone contains the necessary processing hardware to execute commands for the entire swarm. The drones in the swarm are labeled as 102. Each drone is equipped with a laser mounted on gimbals, similar to current technologies such as those offered by DJI for camera mounting. The laser beams emitted by these drones are labeled as 103. The emitted beams possess a typical divergence angle, indicated as 104, which enables the coverage of a wide field of view by the swarm, represented as 107. A magnified view of an individual drone shows the laser mounted beneath its structure, labeled as 106. Active cooling is provided to the lasers by airflow, indicated as 105, which passes over the laser and its heatsink to dissipate heat.

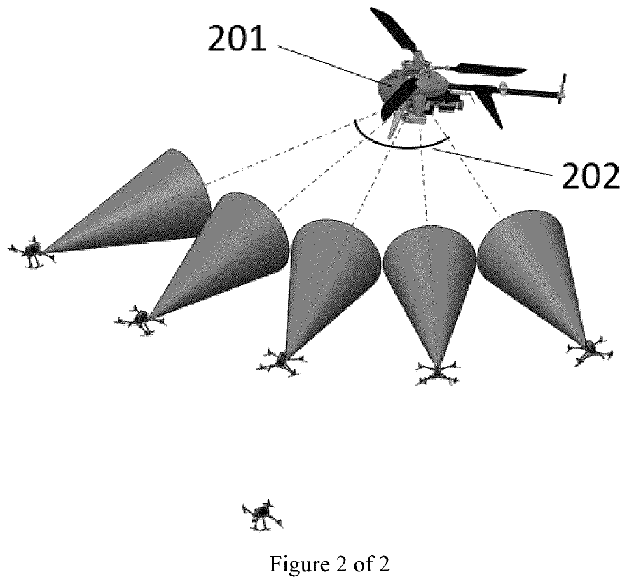

FIG. 2 illustrates the swarm in its secondary operational mode, where a designated target, labeled as 201, is identified. The lasers on all swarm drones are re-aligned to converge their emitted beams onto the target from a distance, focusing their radiation precisely. During this operation, the lasers are temporarily adjusted to operate in a burst mode, significantly increasing their output power to overwhelm the target with concentrated laser radiation, thereby neutralizing its operational capability. The cone-shaped numerical aperture of the lasers emitted by the swarm drones is labeled as 202.

What is claimed is:

1. A drone-based laser system comprising:
(a) a plurality of drones, each having a propeller that contributes to dissipating heat from a laser emitter mounted on the drone without the use of auxiliary cooling means; and
(b) a control system that:
(i) controls the plurality of drones to operate in a detection mode in which each laser emitter emits pulses characterized by low average power and high peak power so as to illuminate and scan a wide field of view for targets; and
(ii) in response to detection of a target, transitions the plurality of drones to a cooperative engagement mode in which the drones autonomously align and focus their laser beams on the detected target and increase the average emitted power of their laser emission so that the combined energy incident on the target is sufficient to dazzle or damage the target; and
wherein the detection mode comprises the majority of the system's operational time such that airflow generated by the propellers provides sufficient convection cooling for each laser emitter during normal operation.

2. The system of claim 1, wherein the propeller arrangement that provides lift and propulsion also generates the airflow used to remove heat from the laser emitter, thereby eliminating the need for separate fans or liquid-cooling systems.

3. The system of claim 1,
wherein each drone further comprises an imaging sensor configured to detect reflected laser radiation and to transmit positional information to the control system,
and wherein the control system triangulates the position of the detected target based on image data received from a plurality of drones.

4. The system of claim 1,
wherein, during the cooperative engagement mode, the control system synchronizes the relative positions and beam directions of the plurality of drones such that their respective laser beams remain co-aligned on the detected target despite drone motion or environmental disturbances.

5. The system of claim 1,
wherein each laser emitter is operated in a pulsed regime during the detection mode and in a higher-power continuous or quasi-continuous regime during the cooperative engagement mode; and wherein each drone includes a temperature sensor configured to monitor the laser emitter temperature and automatically reduce or interrupt laser output when a predetermined temperature threshold is exceeded to maintain thermal stability.

6. The system of claim 1,
wherein each drone comprises a laser source configured to emit a laser beam toward a target region and a cooperative imaging sensor positioned to receive radiation back-reflected from the target;
the imaging sensor being arranged to determine the angular direction of the detected target relative to the optical axis of the laser source; and
wherein the control system is configured to compute the spatial position of the target by triangulation of the multiple angular directions simultaneously measured by the imaging sensors of at least two drones within the swarm, thereby enabling precise localization of the target for coordinated laser focusing and engagement.

7. The system of claim 3,
wherein each imaging sensor is equipped with a bandpass filter configured to transmit primarily the laser wavelength and captures sequential image frames of a target scene and transmits the image data to the control system, and wherein the control system executes an onboard image-processing algorithm configured to:
(a) extract motion vectors of luminous or reflective points within the scene from frame-to-frame changes to determine movement trajectories of detected objects;
(b) compute relative reflectivity or brightness contrast of the detected objects based on the returned laser illumination intensity; and
(c) classify and prioritize the detected objects according to at least one of their motion magnitude, approach direction, and reflectivity level so as to assign engagement priority levels for optimized cooperative targeting by the plurality of drones.

8. The system of claim 1, wherein the drones are equipped with wireless communication modules
configured to transmit positional, thermal, and imaging data in real time, thereby ensuring synchronized laser emission timing and coordinated beam focusing within the swarm.

9. The system of claim 1, further comprising a central or distributed control unit configured to (a) monitor the operational status and positional data of each drone, and (b) transmit command instructions governing flight formation, laser-emission timing, and cooperative engagement of the swarm.
